(19) United States
(12) Patent Application Publication
(10) Pub. No.: US 2009/0211142 A1
(43) Pub. Date: Aug. 27, 2009

(54) Oar apparatus and method of use

(76) Inventor: Andrew Sackett, Rye, NY (US)

Correspondence Address: Bakos & Kritzer, LLP, 27 Laurel Avenue, Summit, NJ, 07901, US

(21) Appl. No.: 12/072,250

(22) Filed: Feb. 25, 2008

(51) Int. Cl. A01K 97/10; B63H 16/04

(52) U.S. Cl. 43/21.2; 440/101

(57) ABSTRACT

An apparatus and method for allowing a fisherman to utilize an oar or paddle while maintaining possession and control of a fishing pole rod and fishing reel. The oar or paddle is designed to be an integral member with or affixed to the fishing pole rod and fishing reel without altering the full movement and operation of the fishing pole rod and fishing reel.

### FIELD OF THE INVENTION

The present invention generally relates to the field of fishing equipment or apparatus, and especially fishing rod and reel devices for use while in a water-based mobile vehicle including row boats, kayaks, rafts, and the like. More specifically, the present invention relates to a system for incorporating a fishing rod and fishing reel with a permanently integrated or attachable and removable boat-rowing or propelling oar or paddle apparatus for allowing a user to continue full use and control of the fishing rod and fishing reel while also utilizing the oar to move and position the water-based vehicle.

### BACKGROUND OF THE INVENTION

Ordinarily it is a difficult task to manage a fishing rod and reel while manually controlling a watercraft such as a rowboat, kayak, canoe, raft, or other non-motorized water-based vehicle or in some instances a motorized vehicle. It is especially difficult to manage a fishing rod and reel while manually controlling a sea, whitewater, surf, racing, hybrid, multi-person, or other type of kayak due to the space constraints and the coverdeck and spraydeck or sprayskirt configuration which limits the access to temporary storage space for a kayak user. However, it is apparent that an oarsman of a water-based vehicle often utilizes a fishing rod and reel and in order to manage the movement of the water-based vehicle with an oar, the passenger must relinquish control of the fishing rod and fishing reel, often placing the fishing rod and fishing reel within the water-based vehicle or positioning it within a common fishing rod holder apparatus. While the oarsman propels, positions or holds the water-based vehicle from movement against wind, currents, or wave conditions the fishing rod and fishing reel currently must be unmanned. This lack of control greatly diminishes the pleasure of the sport of fishing as an opportunity to set a hook for catching a fish can be immediately lost. Further, it is well known in the art that simulating the jerking motion of a live fish replicated by a lure, bait, fly, etc. attracts certain species of fish which are inclined to strike a moving object and as a result this loss of control of the fishing rod to release the fishing line, bring in the fishing line, or take other action to move and position the fishing line to stimulate movement of the bait, fly or lure may result in a lost opportunity to catch a fish. The need to simultaneously manage various equipment such as fishing equipment while onboard a water-based vessel is well documented, and the United States Patent and Trademark Office is replete with examples of attempts to satisfy this need. However, most of the references address systems and methods for fishing rod and fishing reel storage or methods for holding the fishing rod and fishing reel while not in use. Such-examples are not particularly available to the user of various water-based vehicles such as a kayak due to constraints on design and construction in light of the inability to mount a fishing rod holder thereto. For example, one of ordinary skill in the art will recognize that the tunnel or torpedo shape of a kayak and the material of manufacture (commonly rotomolded plastic, wood, fabrics over wooden or aluminum frames, fiberglass, Kevlar, or carbon fiber) do not allow for the mounting of mechanisms to secure fishing poles and/or oars. Further examples include securing an oar or paddle within an oar lock, often attached to a gunwale. All of these references fail to satisfy the need for an integrated oar fishing pole device which allows an oarsman to manage the propulsion of the water-based vessel while still maintaining complete control of the fishing pole and reel.

Few references are available which attempt to address the need to manage both an oar and fishing rod and reel. For example, the United States Patent and Trademark Office has reviewed patent applications purporting to provide solutions for controlling a fishing line and/or fishing rod while still managing an oar, however, these systems have different objectives and exhibit many limitations, as each fails to provide a single integrated device for controlling an oar and a fishing pole simultaneously.

A first reference, depicted in FIG. 1A (PRIOR ART) entitled “One-Handed Oar for Fisherman” to Powell et al. U.S. Pat. No. 3,039,120 is directed to an oar device with designed handle allowing for the one-handed use by an oarsman. With only one hand occupied, Powell et al. purports that a fisherman can release the paddle from his or her grasp at desired intervals so as to manage a fishing pole with two hands at any desired time. Specifically, Powell et al. acknowledges the difficulty in maneuvering a boat with an oar in a one-handed manner while fly-fishing yet “many fisherman nevertheless attempt, quite awkwardly and inconveniently, to the use the oar in a makeshift manner” and Powell et al. further declares “[h]aving been repeatedly confronted with the difficulties above touched upon it is obvious that there has long existed for a special purpose temporarily usable oar expressly constructed and designed that it may be successfully adapted to one-handed short distance boat moving needs. It follows that an obvious object in the instant matter is to offer to provide fisherman with a simple, practical and easy-to-use one-handed boat paddling and moving oar.” (col. 1, lns. 26-34) Clearly, Powell et al. recognizes the need in the art and offers a solution. However, as stated, Powell et al.'s solution is primarily designed for use as a “temporarily usable oar” since in order to utilize the oar, a fisherman must release his or her grip on the fishing pole to activate the motion of the oar as the oar is merely “stored” on the arm during periods of inactivity. It will be readily apparent to those of ordinary skill in the art that Powell et al. exhibits additional shortcomings as viewed in light of the present invention.

Turning to a second reference, Caldwell U.S. Pat. No. 5,588,243 discloses a fishing line device “for transmitting irregular jerking or darting motions to the end of a fishing line from a boat propelled by an oar including apparatus for securing a modified downrigger release clamp to a pulley line suspended between the end of a row boat oa[r] and a bracket adjacent to the handle of the oar.” (Abstract) While the Caldwell disclosure recognizes the inherent difficulty in maintaining a fishing pole and managing the rowing action required for propelling a row boat, the Caldwell disclosure, as depicted in FIG. 1B (PRIOR ART), exhibits a inherent flaw in the fact that while an oarsman manages the oar, it is apparent from the figure that the fishing pole is unmanned. The Caldwell device merely improves the movement of the fishing line but fails to provide a mechanism for the user to manage the fishing pole and oar simultaneously while maintaining possession of both devices.

Therefore it is clear that a need exists for an apparatus and method for use by an oarsman to facilitate the movement or stability of a water-based vehicle while allowing the oarsman full maintenance, possession and utilization of a fishing pole and reel apparatus. Further there exist a need to provide an oar attachment mechanism which may be easily and efficiently removed form a portion of a fishing rod and fishing reel allowing an oarsman to utilize the oar while maintaining control, possession, and utilization of a fishing pole and reel.

### SUMMARY OF THE INVENTION

The present invention provides an apparatus and method for attaching and removing a boat-rowing or propelling oar or paddle apparatus allowing a user to continue full use and control of a fishing rod and fishing reel while also utilizing the oar to move and position the water-based vehicle.

In the various embodiments disclosed herein it is a primary object of the present invention to provide a simple and effective oar apparatus including an oar portion permanently secured and integral therewith to an end of a fishing pole rod and fishing reel combination for use by an oarsman to facilitate the movement of a water-based vehicle such as a kayak or stabilize the water-based vehicle by positioning an oar portion of the disclosed apparatus in the water while maintaining possession and utilization of the fishing pole rod and fishing reel combination.

It is a further object of the present invention to provide a simple and effective oar apparatus including an oar portion temporarily secured to an end of a fishing pole rod and fishing reel combination for use by an oarsman to facilitate the movement of a water-based vehicle such as a kayak or stabilize the water-based vehicle by positioning an oar portion of the disclosed apparatus in the water while maintaining possession and utilization of the fishing pole rod and fishing reel combination wherein the oar portion is readily and efficiently detachable from the end of the fishing pole rod and fishing reel combination.

In another embodiment, it is a further object of the present invention to provide a simple and effective apparatus including an oar portion permanently secured, but easily replaceable, to an end of fishing pole rod and fishing reel combination for use by an oarsman to facilitate the movement of a water-based vehicle such as a kayak or stabilize the water-based vehicle by positioning an oar portion of the disclosed apparatus in the water while maintaining possession and utilization of the fishing pole rod and fishing reel combination.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment and alternate embodiments set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1A (PRIOR ART) shows the Powell et al. U.S. Pat. No. 3,039,120 prior art entitled “One-Handed Oar for Fisherman” depicting a substantially conventional lower oar portion and specialized upper oar portion designed hand-grip allowing for a user to operate the apparatus with one hand while allowing a user's second hand to operate a fishing pole.

FIG. 1B (PRIOR ART) shows the Caldwell U.S. Pat. No. 5,588,243 prior art entitled “Fishing Line Device” depicting a downrigger release device mounted to the end of a conventional oar for providing a stop and go motion of a lure attached to the fishing line.

FIG. 2 depicts a front planar view of the oar attachment in an unsecured position in relation to a fishing pole rod and reel in accordance with the preferred embodiment of the present invention.

FIG. 3 depicts a front planar view of the oar attachment in a secured position in relation to a fishing pole rod and reel in accordance with the preferred embodiment of the present invention.

FIG. 4 depicts a front planar expanded view of the oar attachment in an unsecured position in relation to a fishing pole rod and reel in accordance with the preferred embodiment of the present invention.

FIG. 5 depicts a front planar expanded view of the oar attachment in a secured position for attaching a fishing pole rod and reel therein in accordance with the preferred embodiment of the present invention.

FIG. 5A depicts a top planar view of the sleeve cavity of the oar attachment of FIG. 5 emphasizing the internal cross-member for securing the fishing pole butt therein to prevent spinning of the oar attachment while in use by the oarsman.

FIG. 6 depicts a front planar view of an oar attachment in a secured position in relation to a fishing pole rod and reel in accordance with an alternate embodiment of the present invention.

FIG. 7 depicts a front planar view of an oar attachment integral with a fishing pole rod and reel in accordance with an alternate embodiment of the present invention.

FIG. 8 depicts a front planar view of an oar attachment attachable with a clip system for attaching the oar attachment to a fishing pole rod and reel in accordance with an alternate embodiment of the present invention.

FIG. 8A depicts an expanded planar view of the oar attachment depicted in FIG. 8, attachable with a clip system for attaching the oar attachment to a fishing pole rod and reel in accordance with an alternate embodiment of the present invention.

FIG. 9 depicts a front planar view of an bar attachment attachable via a screw-in system for attaching the oar attachment to a fishing pole rod and reel in accordance with an alternate embodiment of the present invention.

FIG. 10 depicts a front planar view of an oar attachment attachable via a spring-based pushpin system for attaching the oar attachment to a fishing pole rod and reel in accordance with an alternate embodiment of the present invention.

FIG. 11 depicts a front planar view of an oar attachment attachable via a secondary clip for attaching the oar attachment to a fishing pole rod and reel in accordance with an alternate embodiment of the present invention.

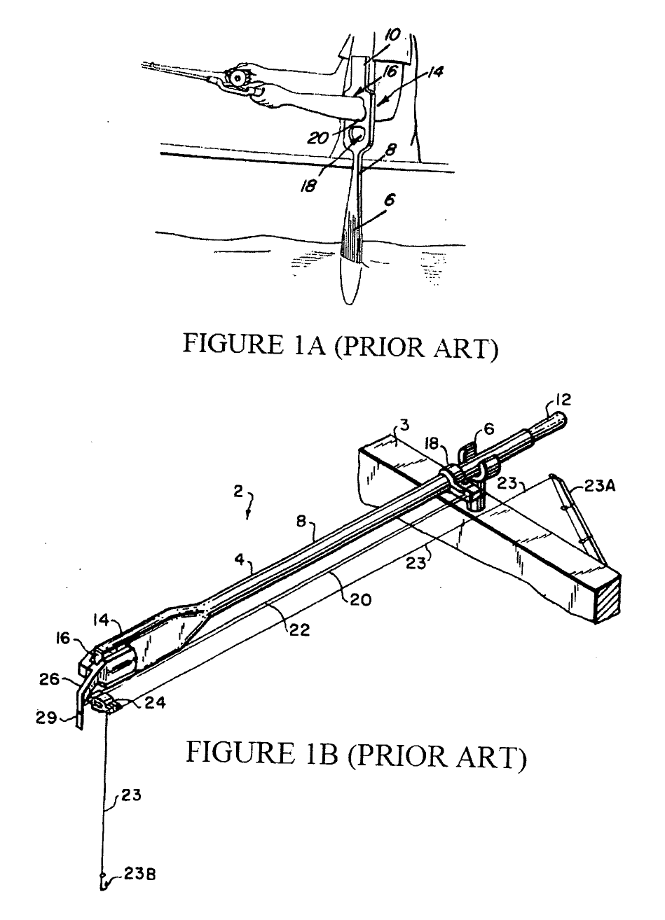

### DETAILED DESCRIPTION OF THE PREFERRED EMBODIMENT

A detailed illustrative embodiment as well as several alternate embodiments of the present invention are disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiments for purposes of disclosure and to provide a basis for the claims herein which define the scope of the present invention. The following presents a detailed description of a preferred embodiment (as well as some alternative embodiments) of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

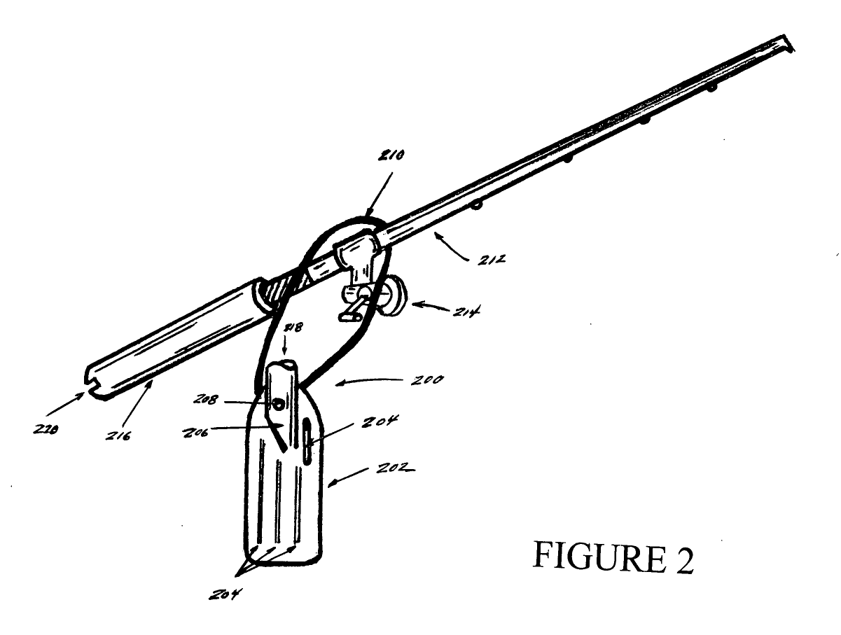

Referring first to FIG. 2, depicted is an illustration of the apparatus in accordance with the preferred embodiment of the present invention. Specifically, the present invention is directed to a paddle or oar attachment 200 composed of oar 202 and securing cord 210. Oar 202 can be manufactured of any common material known in the art and in the preferred embodiment oar 202 is manufactured of a stiff and lightweight material. For example, oar 202 can be manufactured of a natural material such as wood, commonly basswood or maple laminate, or a synthetic material such as carbon fiber, fiberglass, glass-filled polypropylene, nylon composite, aluminum reinforced, or any composites of the referenced materials or other like materials common in the art. Further, oar 202 can be manufactured as a solid piece with a typically flat blade end and a generally triangular second end connected by two parallel blade portions for a generally rectangular shape. While this shape is common in the art, allowing for proper flow and movement of oar 202 through the water to allow for propulsion by the oarsman, one of ordinary skill in the art will recognize that oar 202 can be manufactured in a wide variety of shapes.

Oar 202 can be manufactured of various sizes standard in the art. In the preferred embodiment, it has been determined that oar 202, manufactured of approximately ten to fourteen inches in length, six to eight inches in width, one quarter to one half inches in thickness at blade end and one and one half inches to two and one half inches in thickness proximate cavity shaft 206 is recommended for use in a fresh water environment. Generally, due to the varying properties with respect to currents and fishing apparatus in various environments, the dimensions of oar 202 may be widely varied without departing from the scope of the present invention.

Still referring to FIG. 2, in the preferred embodiment of the present invention oar 202 is depicted having ribbed protrusions 204 to increase the friction of impact of oar 202 when guided through the water. Ribbed protrusions 204 may also be manufactured as apertures, indentations, or the like to further assist in forcing the movement of the water over or through oar 202. The inclusion of ribbed protrusions 204, designed as apertures, indentations, or the like is preferred so to decrease the overall weight of oar 202.

The generally triangular second end of oar 202 contains cavity shaft 206 designed to accept the grip end 216 of fishing pole 212 at access rim 218 of cavity shaft 206. Access rim 218 and cavity shaft 206 of the present invention are designed to accept grip end 216 of fishing pole 212 of various sizes. To secure fishing pole 212 within cavity shaft 206, grip end 216 of fishing pole 212 is wedged by a user through access rim 218 into cavity shaft 206. Cavity shaft 206 includes cross-member therein (not shown in FIG. 2) to further secure grip end 216 and resist torsional movement of fishing pole 212. It is further contemplated by the present disclosure that due to the fluctuations of the diameter of various fishing poles the internal diameter of cavity shaft 206 may be manufactured of various accommodating sizes. Further, it will be readily apparent to those of ordinary skill in the art that due to fluctuations in the diameters of grip end 216 of fishing pole 212, sleeves may be utilized to increase the diameter of grip end 216 to improve the snug fit within cavity shaft 206. Sleeves can be manufactured of high-quality cork, foam material, or other like material known in the art which can be designed to increase the diameter of grip end 216 of fishing pole 212. The snug fit within cavity shaft is further enhanced by the employment of lock fastener 208. Lock fastener 208 is designed to impinge on grip end 216 of fishing pole 212 thereby restricting torsional mobility and preventing fishing pole 212 from releasing from cavity shaft 206. Lock fastener 208 can be manufactured of common wing-type nut device however other screw type or other securing mechanisms may be employed while keeping with the present objectives of the preferred embodiment. In lieu of or in addition to lock fastener 208, a screw-in/lock-in system may be employed so that the grip end 216 of fishing pole 212 can be inserted into cavity shaft 206 and screwed into place with a simple twist or twisting motion. It will also be readily apparent that in many instances, lock fastener 208 may not be employed to allow for quicker removal of oar apparatus 200. It will be clear to one of ordinary skill in the art that lock fastener 208 can be any component or means which temporarily secures fishing pole 212 into cavity shaft 206 without departing from the scope of the present invention.

Still referring to FIG. 2, oar attachment 202 includes securing cord 210. In accordance with the preferred embodiment of the present invention, securing cord 210 is attached to oar 202 at the generally triangular end of oar 202. Securing cord 210 can be integral with oar 202 and attached to oar 202 during the manufacture process such as during the polypropylene injection-molded or compression-molded step wherein oar 202 is formed. It is further contemplated that securing cord 210 can be introduced post-formation of oar 202 through the use of sea-worthy common fasteners such as nuts and bolts, grommets, etc. Securing cord 210 can be manufactured of common braided nylon or cotton construction allowing for a level of elasticity enabling a user to extend securing cord 210 so that oar 202 can be extended beyond grip end 216 of fishing pole 212 but recoil to apply sufficient tension when oar attachment 200 is placed in position. While braided nylon is set forth as the preferred construction, one of ordinary skill in the art will readily recognize that various materials may be employed to accomplish the same objectives such as polypropylene lines, polyester lines, or other similar lines exhibiting a degree of elasticity. It is also contemplated by the present disclosure that composite lines may be utilized. Securing cord 210 stabilizes oar 202 when grip end 216 is secured within cavity shaft and securing cord 210 is wrapped around fishing pole 212 and fishing reel 214. Depending on the structure of fishing pole 212 and fishing reel 214, securing cord 210 can be designed to be secured at fishing reel 214 without interacting with fishing pole 212. In addition, securing apparatus (not shown) may be employed to attach securing cord 210 to fishing pole 212 or fishing reel 214 so as to maintain contact with same. The use of securing apparatus is preferred so that oar attachment 200 can be removably attached to fishing pole 212 or fishing reel 212 primarily when not attached so it is proximate to fishing pole 212 to allow for quick and easy employment by the oarsman.

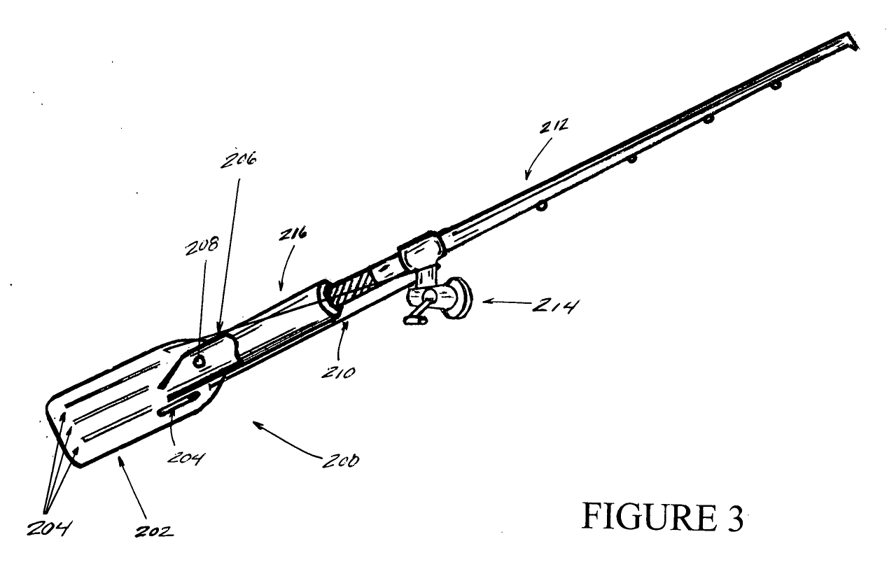

Turning to FIG. 3, depicted is a front planar view of oar attachment 200 as set forth in FIG. 2 in a secured position in relation to fishing pole 212 and fishing reel 214 in accordance with the preferred embodiment of the present invention. Oar attachment 200 composed of oar 202 and securing cord 210 is affixed to grip end 216 of fishing pole 212. To affix oar attachment 200 to grip end 216 of fishing pole 212 the oarsman stretches securing cord 210. When securing cord 210 is expanded, oar attachment 200 can be affixed to grip end 216 of fishing pole 212. Tension in securing cord 210 is then relaxed, but in accordance with the preferred embodiment of the present invention, some tension is maintained in securing cord 210. Maintaining tension in securing cord 210 helps keep oar attachment 200 from migrating physically from grip end 216 of fishing pole 212. This is also useful during the implementation and removal of lock fastener 208, as the oarsman can lock or unlock lock fastener 208 without worrying that oar attachment 200 will slip off grip end 216 unintentionally. The process of affixing oar attachment 200 to grip end 216 of fishing pole 212 is more fully described below.

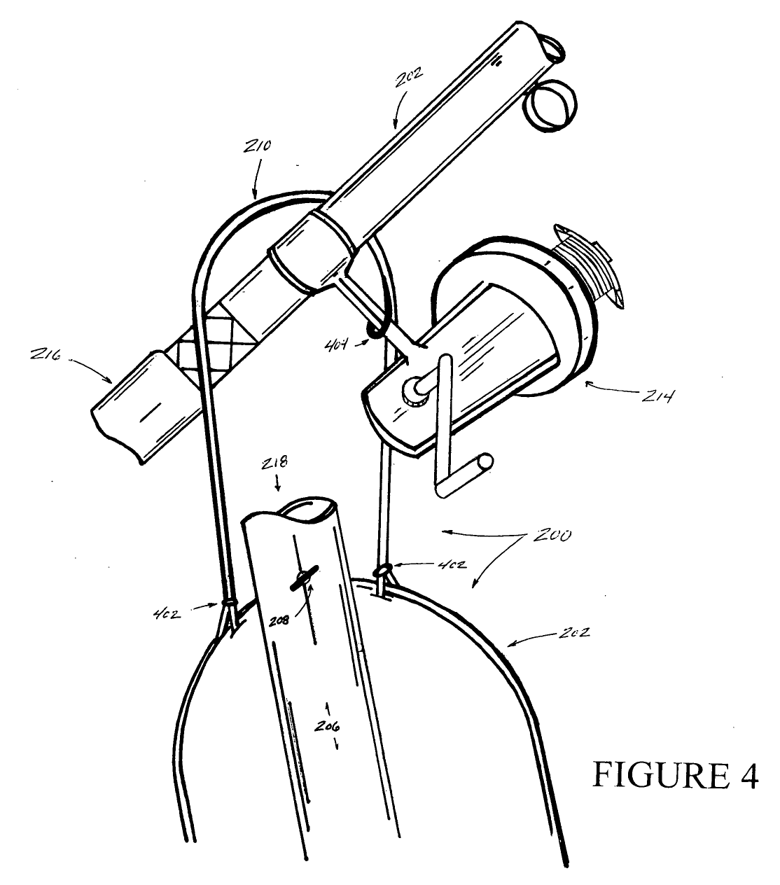

FIG. 4 depicts a front planar expanded view of oar attachment 200 in an unsecured position in relation to fishing pole 212 and fishing reel 214 in accordance with the preferred embodiment of the present invention. Set forth is oar attachment 200 including oar 202 and securing cord 210. Securing cord 210 is shown un-affixed and generally in unstrained position. In this expanded view of the preferred embodiment of the present invention, securing cord 210 exhibits fastening strap 404. Fastening strap 404 can be manufactured of composite nylon substantially water-resistant material and further can employ hook and loop fasteners. The hook and loop fasteners are designed to allow a user to loosely fasten oar attachment to a portion of fishing reel 214 and/or fishing pole 212 (at or above grip end 216) so that oar attachment 200 can be readily accessed while in unfastened state. While nylon and hook and loop construction is preferred, it will be readily apparent to one of ordinary skill in the art that various fastening apparatus may be utilized to accomplish the desired task. For example, a rigid fiberglass hook, metal clip, polypropylene or other plastic-type clip, snap construction with polyprolene strap, or other similar objects may be employed.

The expanded view of FIG. 4 further depicts support reinforcements 402 proximate cavity shaft 206 of oar 202. Support reinforcements 402 can be employed to fasten securing cord 210 to oar 202. While it will be readily apparent to those of ordinary skill in the art that various manufacturing techniques can be employed to secure oar 202 to securing cord 210, it is preferred that support reinforcements 402 are manufactured of galvanized metal encased in polypropylene or other synthetic material to prevent wear and deterioration from the elements while in use. However, as previously mentioned, support reinforcements 402 may be replaced in lieu of securing cord 210 manufactured as an integral part of oar 202 upon oar formation at the point of molding.

The expanded view of FIG. 4 further provides a closer look at lock fastener 208. As previously disclosed, lock fastener 208 is designed so that oarsman can manually further secure oar apparatus 200 to grip end 216 of fishing pole 212 when more secure attachment is desired such as instances of prolonged use. Further, while one lock fastener 208 is depicted, it will be readily apparent to those of ordinary skill in the art, that a plurality of lock fasteners 208 may be utilized in the construction without departing from the scope of the present invention.

Still referring to FIG. 4, while cavity shaft 206 is preferably designed to accept grip end 216 of fishing pole 212, it will be readily apparent to those of ordinary skill in the art that access rim 218 of cavity shaft 206 is manufactured of suitable diameter to accept common oar shafts manufactured of carbon fiber, aluminum, wood, etc. Thus, oar apparatus 200 can be utilized as a multi-purpose tool capable of accepting various apparatus.

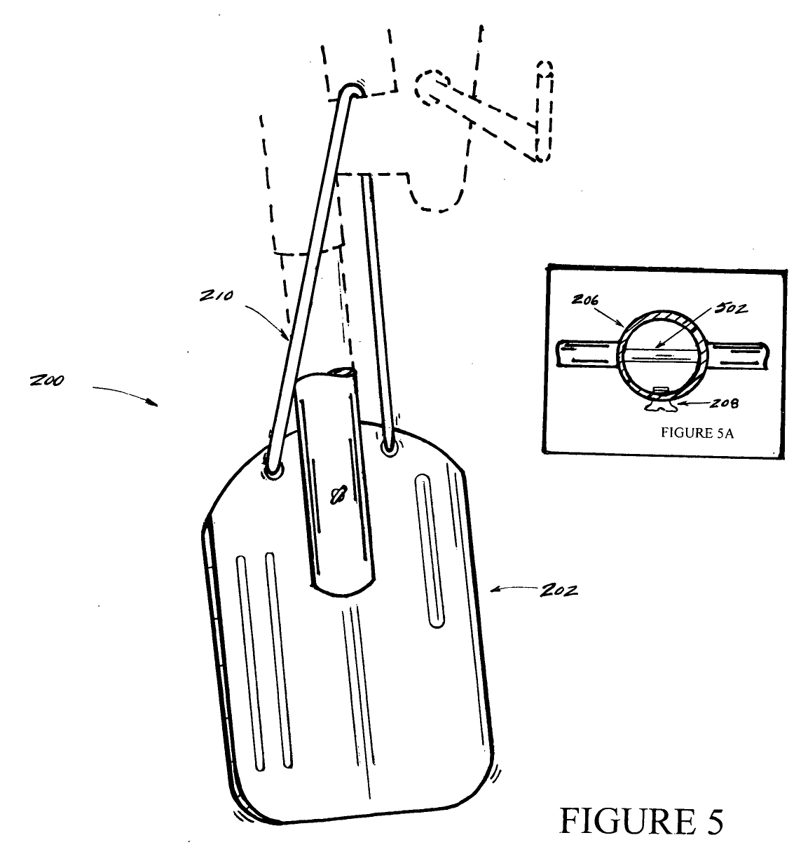

FIG. 5 depicts a front planar expanded view of oar attachment 200 comprising oar 202 and securing cord 210 in a secured position for attaching a fishing pole and reel therein in accordance with the preferred embodiment of the present invention. As shown, securing cord 210 is wrapped around connection portion of fishing reel providing sufficient tension in securing cord 210 so that securing cord maintains placement of oar attachment 200. Once secured, oar attachment 200 is designed to resist the forces common when an oarsman utilizes oar attachment 200 to manage the direction of the water-based vehicle.

Inset FIG. 5A depicts a top planar view of the sleeve cavity of the oar attachment of FIG. 5 emphasizing internal cross-member 502 for securing grip end 216 of fishing pole 212 (depicted in FIG. 2) therein to prevent spinning of the oar attachment while in use by the oarsman. In this embodiment, lock fastener 208 is depicted as traversing the extended portion of cavity shaft 206. Specifically, lock fastener 208 is designed to impinge inserted grip end of fishing pole.

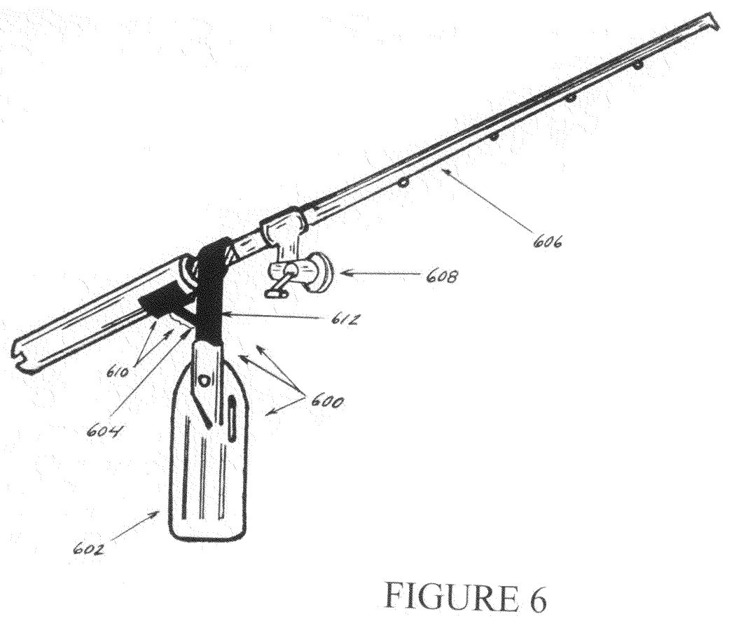

FIG. 6 depicts a front planar view of an oar attachment 600 in secured position in relation to a fishing pole 606 and fishing reel 608 in accordance with an alternate embodiment of the present invention. Oar attachment 600 composed of oar 602 and securing shaft 604 including vertical shaft 612 and angled support member 610 is designed to affix at or near grip end 616 and base portion 614 of fishing pole 606. Securing shaft 604, preferably manufactured of rigid galvanized metal or rigid synthetic material, is designed to lock into place and wrap portions of grip end 616 and base portion 614 of fishing pole 606.

In this alternate embodiment of the present invention, oar 602 is manufactured as a solid construction of standard sizes common in the art. Oar 602 exhibits ribbed protrusions 618, manufactured in the form of expanded sections, apertures, indentations, or the like to assist in forcing the movement of the water over or through oar 602 when progressed through the water by an oarsman.

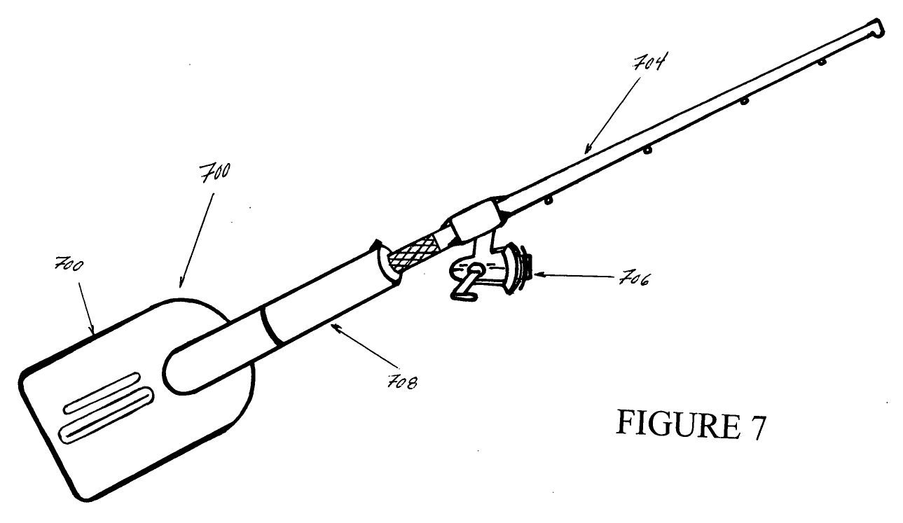

FIG. 7 depicts a front planar view of an oar attachment integral with fishing pole 704 and fishing reel 706 in accordance with another alternate embodiment of the present invention. Oar attachment 700 including oar 702 is manufactured as an integral portion of fishing pole 704 and is attached thereto at grip end 708. While it is preferably manufactured of similar construction to fishing pole 704 and affixed thereto at time of manufacture, it is also contemplated by the present invention that oar attachment 700 is manufactured as supplemental construction. Thus, a user can attach oar attachment 700 to fishing pole post construction of fishing pole 704 using any means known for securing similar items without departing from the scope of this alternative embodiment of the present invention. Oar attachment 700 can be affixed to fishing pole 704 in a substantially permanent fashion, permanent fashion, or removably affixed thereto. It is also contemplated by the present disclosure that lock fasteners may be employed to secure oar attachment 700 to fishing pole 704.

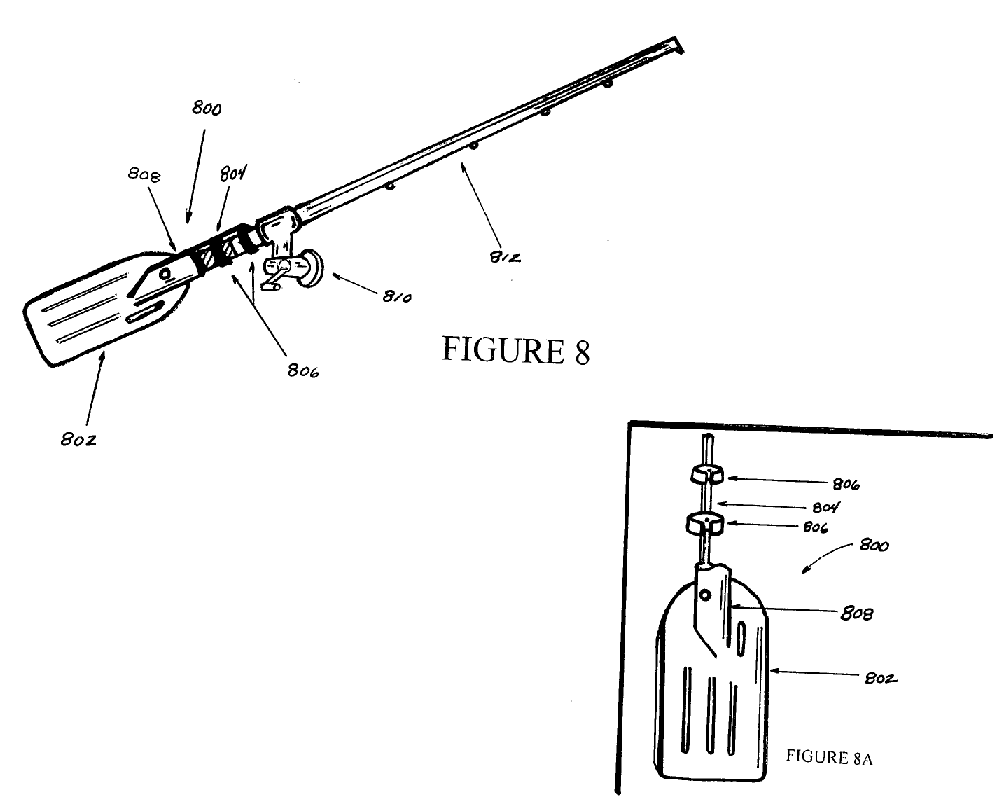

Turning next to FIG. 8 (and FIG. 8A - an expanded frontal view of oar attachment 800 depicted in FIG. 8) depicted is a front planar view of oar attachment 800 attachable with substantially rigid extension clip comprising shaft 804 and at least one rod clip 806 attached thereto for attaching oar attachment 800 to fishing pole rod 812 and fishing reel 810 in accordance with an alternative embodiment of the present invention. In this example, oar attachment 800 includes oar 802, cavity shaft for inserting grip end of fishing pole rod 812 therein, and extension clip comprising shaft 804 and rod clips 806, however, it is contemplated by the present disclosure that any portion thereof may be interchangeable and modifiable to achieve the same objectives of the present disclosure. In this alternative embodiment as depicted, extension clip comprises shaft 804 and two rod clips 806 designed to fasten to the lower portion of fishing pole rod 812 for removably securing oar attachment 800. Rod clips 806 are fastened to the lower portion of fishing pole rod 812 by forcibly pushing rod clips 806 at an open portion of rod clips 806 thereby wrapping around and securing to the lower portion of fishing rod 812. In addition, rod clips 806 are preferably manufactured from a rigid material, however it is contemplated that such material will allow for a slight expansion as the length of open portion of rod clips 806 are designed to be slightly less than the diameter of the lower portion of fishing pole 812. Like other portions of oar attachment 800, rod clips 806 are also preferably manufactured of a material capable of resisting corrosion or other deterioration due to fresh or salt water.

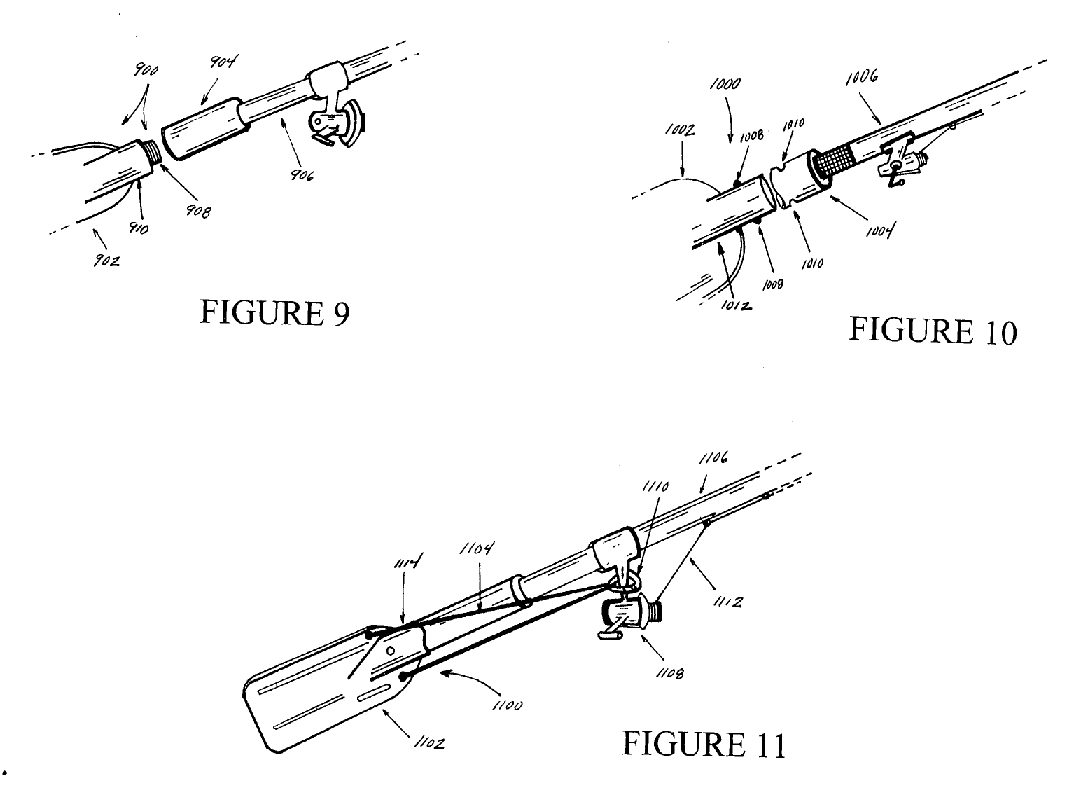

Set forth in FIG. 9 is a front planar view of oar attachment 900 attachable via a screw-in system for attaching oar attachment 900 to a fishing pole rod 906 and fishing reel in accordance with an alternate embodiment of the present invention. Cavity shaft 910 includes a male screw 908 designed to secure oar attachment 900 comprising oar 902 and cavity shaft 910 to grip end 904 of fishing pole 906. Grip end 904 of fishing pole 906 includes a female portion to accept male screw 908. Of course, in keeping with the objectives of the present invention, one of ordinary skill in the art will readily recognize that the male and female screw-in system can be interchangeable between grip end 905 of fishing pole 906 and cavity shaft 910 depending on the desired design of oar attachment 900 and fishing pole 906. One of ordinary skill in the art will also appreciate that different attachment mechanisms can be substituted for the screw mechanism depicted in FIG. 9 without departing from the scope of the present invention.

A further attachment mechanism is described in FIG. 10. In particular, FIG. 10 depicts a front planar view of oar attachment 1000 attachable via a spring-based push pin system for attaching oar attachment 1000.to fishing pole rod 1006 and reel in accordance with an alternative embodiment of the present invention. Protruding push pins 1008 are incorporated with substantially solid cavity shaft 1012 and oar 1002. Grip portion of fishing pole 1006 is designed to accept cavity shaft 1012 of oar attachment 1000 and protruding push pins 1008 are designed so that a user can retract protruding push pins 1008 to allow for insertion into grip portion of fishing pole 1006. Once inserted into grip portion of fishing pole 1006, oar attachment 1000 is further inserted therein so that protruding push pins 1008 reach exposure portals 1010 of grip end of fishing pole 1006 and extend to secure into exposure portals 1010. In the embodiment of the invention depicted in FIG. 10, the spring mechanism allows protruding push pins to expand and generally fill exposure portals 1010 thereby securing oar attachment 1000.

Turning next to FIG. 11, depicted is a front planar view of oar attachment 1100 (comprising oar 1102, cavity shaft 1114, and securing cord 1104) attachable via secondary clip 1110 for attaching oar attachment 1100 to fishing rod 1106 and fishing reel 1108 in accordance with an alternative embodiment of the present invention. One of ordinary skill in the art will readily recognize that the alternative embodiment of FIG. 11 is particularly useful when removably attaching oar attachment 1100 to fishing rod 1106 when fishing line 1112 is already strung from the reel. Notably, oar attachment 1100 can be clipped using secondary clip 1100 without requiring the removal of fishing line 1112 or restringing of fishing line 1112. Secondary clip 1110 is designed to allow sufficient tension in securing cord 1104 so that the oar attachment is properly secured in accordance with the principles of the present invention so as to resist movement of oar attachment 1100 as previously discussed. In this embodiment, secondary clip 1110 can be specifically manufactured to accomplish the desired task or can be other clips or fasteners common in the art such as carabiner clips, swivel clips, screw clips, hook and loop fasteners, tie-down fasteners, hardware clip rings, etc. As will be recognized by one of ordinary skill in the art, other means of attaching secondary clip 1110 can be utilized without departing from the scope of the present invention.

From the foregoing description of the embodiments, which embodiments have been set forth in considerable detail for the purpose of making a complete disclosure of the present invention, it can be seen that the present invention comprises a grip material for increasing the friction between human fingers and a foreign object by providing an intermediate object with a face having increased friction. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

1. An oar apparatus for manipulating a water based vehicle comprising:
a fishing rod;
an oar; and
a securing apparatus for securing said oar to a first end of said fishing rod;
wherein said oar is secured to said fishing rod at said first end, thereby restricting torsional movement of said oar with respect to said fishing rod.

2. An oar apparatus for manipulating a water based vehicle according to claim 1, wherein said first end of said oar further comprises a cavity shaft for receiving said fishing rod.

3. An oar apparatus for manipulating a water based vehicle according to claim 2, wherein said cavity shaft can accommodate fishing rods of various sizes.

4. An oar apparatus for manipulating a water based vehicle according to claim 2, wherein said cavity shaft further comprises a sleeve for additionally restricting the torsional movement of fishing rods of various sizes.

5. An oar apparatus for manipulating a water based vehicle according to claim 2, wherein said cavity shaft further comprises a cross member to additionally restrict torsional movement of said oar with respect to said fishing rod.

6. An oar apparatus for manipulating a water based vehicle according to claim 2, wherein said cavity shaft further comprises a locking apparatus for restricting movement of said oar with respect to said fishing rod.

7. An oar apparatus for manipulating a water based vehicle according to claim 1, wherein said oar further comprises ribbed protrusions to assist in manipulating said water based vehicle.

8. An oar apparatus for manipulating a water based vehicle according to claim 1, wherein said oar is removably attached to said fishing rod.

9. (canceled)

10. An oar apparatus for manipulating a water based vehicle according to claim 1, wherein said oar is manufactured from a substance selected from the group consisting essentially of: wood, carbon fiber, fiberglass, glass-filled polypropylene, nylon composite, aluminum reinforced, or any composites thereof.

11. An oar apparatus for manipulating a water based vehicle according to claim 1, wherein said securing apparatus comprises an elastic cord.

12. An oar apparatus for manipulating a water based vehicle according to claim 12, wherein said elastic cord is of sufficient dimension such that said elastic cord maintains at least some tension when said oar is secured to said fishing rod.

13. An oar apparatus for manipulating a water based vehicle according to claim 12, wherein said elastic cord is attached to said fishing rod at a fishing reel.

14. An oar apparatus for manipulating a water based vehicle according to claim 12, wherein said elastic cord is manufactured of nylon.

15. An oar apparatus for manipulating a water based vehicle according to claim 12, wherein said elastic cord is manufactured of cotton.

16. (canceled)

17. An oar apparatus for manipulating a water based vehicle according to claim 1, further comprising a secondary clip for removably attaching said oar to said fishing rod without removing or restringing fishing line threaded through said fishing rod.

18-20. (canceled)
